(19) United States
(12) Patent Application Publication
(10) Pub. No.: US 2025/0272994 A1
(43) Pub. Date: Aug. 28, 2025

(54) STATISTICAL ANALYSIS-BASED TECHNIQUES FOR DETERMINING A PREFERRED TRANSFORMATION TYPE FOR 3D IMAGE PROCESSING USING MACHINE LEARNING

(71) Applicant: Cognex Corporation, Natick, MA (US)

(72) Inventors: Hongwei Zhu, Natick, MA (US); Daniel Alejandro Moreno, Northbridge, MA (US)

(73) Assignee: Cognex Corporation, Natick, MA (US)

(21) Appl. No.: 19/064,278

(22) Filed: Feb. 26, 2025

Related U.S. Application Data
(60) Provisional application No. 63/558,016, filed on Feb. 26, 2024.

(51) Int. Cl. G06V 20/64; G06T 7/00; G06V 10/26; G06V 10/74; G06V 10/75; G06V 10/764; G06V 10/77; G06V 10/774; G06V 10/82

(52) U.S. Cl. CPC G06V 20/64; G06T 7/0004; G06V 10/758; G06V 10/761; G06V 10/7715; G06V 10/774; G06V 10/82; G06T 2200/04; G06T 2207/20081; G06T 2207/20084; G06V 10/26; G06V 10/764

(57) ABSTRACT

The techniques described herein relate to methods and systems for three-dimensional (3D) image processing using deep learning model pre-trained with two-dimensional (2D) images. The techniques include transforming a 3D representation to a 2D map, which can be input to the model. The output of the model could be a defect segmentation mask, or a probability of the input belonging to a given category. The input 2D image can result from a particular transformation configuration. The techniques described herein provide for an effective and efficient method of identifying a transformation type for applications such as 3D data-based classification, anomaly detection and segmentation. The techniques described herein perform statistical analysis over a set of training samples to identify a transformation type. The statistical analysis can include histograms of pixel values.

### RELATED APPLICATION

This application claims priority under 35 U.S.C. § 119(e) to U.S. Provisional Application Ser. No. 63/558,016, titled “STATISTICAL ANALYSIS-BASED TECHNIQUES FOR DETERMINING A PREFERRED TRANSFORMATION TYPE FOR 3D IMAGE PROCESSING USING MACHINE LEARNING,” filed on Feb. 26, 2024, which is herein incorporated by reference in its entirety.

### FIELD

The techniques described herein relate generally to methods and systems for statistical analysis-based techniques for determining a preferred transformation type for three-dimensional (3D) inspection (e.g., classification, anomaly detection and/or segmentation) using machine learning.

### BACKGROUND

Machine vision systems are generally configured to receive and/or capture images of a scene. Some images, such as 3D point clouds, may have three-dimensional (3D) information, and some images such as RGB images may have two-dimensional (2D) information. Machine vision systems are also generally configured to analyze the images to perform one or more machine vision tasks. For example, machine vision systems can be configured to receive or capture images of objects and to analyze the images to identify the objects (e.g., to classify objects) and/or inspect the objects (e.g., for possible manufacturing defects). As another example, machine vision systems can be configured to receive or capture images of symbols and to analyze the images to decode the symbols. Accordingly, machine vision systems generally include one or more devices for image acquisition and image processing.

### SUMMARY

Aspects of the present disclosure relate to methods and systems for three-dimensional (3D) inspection (e.g., classification, anomaly detection and/or segmentation).

Some embodiments relate to a method for identifying a preferred transformation type of three-dimensional (3D) data for an image processing application using two-dimensional (2D) maps derived from 3D data. The method can comprise (a) receiving a 3D representation of a scene; (b) transforming the 3D representation of the scene to a first 2D map for a first transformation type; (c) transforming the 3D representation of the scene to a second 2D map for a second transformation type; (d) generating a first statistical analysis corresponding to at least a portion of the first 2D map; (e) generating a second statistical analysis corresponding to at least a portion of the second 2D map; (f) obtaining respective values by analyzing the first statistical analysis and the second statistical analysis; and (g) identifying a preferred transformation type from the first and second transformation types based at least in part on the respective values.

Optionally, at least one of the first statistical analysis or the second statistical analysis comprises a histogram.

Optionally, the first statistical analysis and second statistical analysis each comprise a count of pixels that are within a series of bins that each have an associated range of pixel values.

Optionally, generating the first statistical analysis further comprises determining the counts of pixels that are within the series of bins per each channel of the first 2D map, or determining the counts of the pixels that are within the series of bins per a combined channel comprising two or more channels of the first 2D map.

Optionally, the respective values each comprise a distance.

Optionally, the 3D representation of the scene includes at least one of a point cloud, a mesh, or a voxel grid.

Optionally, the preferred transformation type represents a configuration of a set of features including at least one of height, normal vector, surface details, and curvature.

Optionally, the image processing application comprises using a deep learning network to perform classification, anomaly detection, and/or segmentation of the 3D representation of the scene.

Optionally, the image processing application comprises using a 2D deep learning model that was pre-trained using a set of 2D images.

Optionally, the first statistical analysis corresponds to the entire map of the first 2D map.

Optionally, the 3D representation is a first 3D representation, the method further comprising: receiving a second 3D representation; and repeating steps (b)-(f) for the second 3D representation.

Optionally, the second 3D representation is of the scene.

Optionally, the second 3D representation is of a different scene.

Optionally, the first 3D representation is within a first category, the second 3D representation is within a second category, and the method further comprises: receiving a third 3D representation within the first category, repeating steps (b)-(f) for the third 3D representation, receiving a fourth 3D representation within the second category, and repeating steps (b)-(f) for the fourth 3D representation.

Optionally, analyzing the statistical analyses comprises using criteria, including: a consistency among training samples within each category of a plurality of categories including the first and second category; or a distance between each training sample and a nearest neighbor of the training sample, wherein the training samples include the 2D maps derived from the first 3D representation, the second 3D representation, the third 3D representation, and the fourth 3D representation.

Optionally, analyzing the first statistical analysis and the second statistical analysis to obtain the respective values comprises: comparing the first statistical analysis of the first 3D representation to the first statistical analysis of the second 3D representation; and comparing the second statistical analysis of the first 3D representation to the second statistical analysis of the second 3D representation.

Optionally, the method further comprises identifying the nearest neighbor for each training sample.

Optionally, identifying the nearest neighbor includes determining a normalized Gaussian distance between two statistical analyses of a same transformation type.

Optionally, the first statistical analysis comprises: a labeled statistical analysis corresponding to a labeled region of a training sample, the training sample including the first 2D map; and a surrounding statistical analysis corresponding to an area surrounding the labeled region of the training sample.

Optionally, the first statistical analysis comprises analyzing a difference between the labeled statistical analysis and the surrounding statistical analysis.

Optionally, the method further comprises measuring the difference between the labeled statistical analysis and the surrounding statistical analysis using a dissimilarity feature.

Optionally, the dissimilarity feature comprises a distance between two corresponding statistical analyses.

Optionally, the 3D representation includes a first 3D representation portion within a first category, the at least a portion of the first 2D map and the at least a portion of the second 2D map correspond to the first 3D representation portion, the second statistical analysis comprises: a second labeled statistical analysis corresponding to a second labeled region of a second training sample, the second training sample including the second 2D map; and a second surrounding statistical analysis corresponding to an area surrounding the second labeled region of the second training sample, and the method further comprises: receiving a second 3D representation within a second category and repeating steps (b)-(f) for the second 3D representation, and/or generating a third statistical analysis corresponding to at least a second portion of the first 2D map and generating a fourth statistical analysis corresponding to at least a second portion of the second 2D map, wherein the second portions correspond to a second 3D representation portion within a second category of the 3D representation.

Optionally, the first statistical analysis and the second statistical analysis of the first 3D representation portion are compared to: the first and second statistical analysis of the 2D map of the second 3D representation, respectively, and/or the third and fourth statistical analysis.

Optionally, the method further comprises selecting the first category or the second category based on the comparison for each of the first transformation type and second transformation type.

Optionally, the method further comprises selecting the first transformation type or second transformation type based at least in part on a dissimilarity feature.

Optionally, the first statistical analysis corresponds to each labeled region of a same category of the first 2D map.

Some embodiments relate to a system comprising at least one processor configured to perform one or more operations described herein.

Some embodiments relate to a non-transitory computer readable medium comprising program instructions that, when executed, cause at least one processor to perform one or more operations described herein.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a schematic diagram illustrating a machine vision system, according to some embodiments.

FIG. 2 is a block diagram of an exemplary system for three-dimensional (3D) inspection, according to some embodiments.

FIG. 3 is a block diagram of an exemplary two-dimensional (2D) map generator of the system for 3D inspection of FIG. 2, according to some embodiments.

FIG. 4 is a schematic diagram illustrating an exemplary processing by a projection generator of the 2D map generator of FIG. 3, according to some embodiments.

FIG. 5 is an exemplary flowchart illustrating a method for identifying a transformation type, according to some embodiments.

FIG. 6A is a 2D projection image of an object with two lids.

FIG. 6B is a histogram for the 2D projection image of FIG. 6A, according to some embodiments.

FIG. 6C is a labeled 2D projection image of an object.

FIG. 6D is a histogram for the labeled 2D projection image of FIG. 6C, according to some embodiments.

FIG. 6E is a histogram for the labeled 2D projection image of FIG. 6C, according to some embodiments.

FIG. 7 is an exemplary flowchart illustrating a method for determining a transformation type, according to some embodiments.

FIG. 8 illustrates an example of comparison results for classification and/or anomaly detection, according to some embodiments.

FIG. 9 is an exemplary flowchart illustrating a method for determining a transformation type, according to some embodiments.

FIG. 10A is a 3D point cloud of a battery surface.

FIG. 10B is a 2D map of the battery surface shown in FIG. 10A, according to some embodiments.

FIG. 10C is a labeled mask image that can be generated based on the 2D map shown in FIG. 10B, according to some embodiments.

FIG. 11A is an exemplary projection option, according to some embodiments.

FIG. 11B is another exemplary projection option, according to some embodiments.

### DETAILED DESCRIPTION

Three-dimensional (3D) representations of a scene, such as 3D point clouds, provide popular representations of a scene using 3D information, such as (x, y, z) positions. The scene can include, for example, objects under inspection or analysis, and can be observed by a 3D sensor that produces a 3D point cloud, connected mesh and/or some other 3D representation of the scene. With the development of deep learning technologies, it can be desirable to analyze these 3D representations with deep learning-based approaches. For example, it can be desirable for machine vision applications to take into account shape features such as surface curvature, surface normal directions, and/or height, which can be represented in a 3D representation. The techniques described herein provide methods and systems for 3D machine vision applications using a deep learning model that is pre-trained using a set of traditional two-dimensional (2D) images. Examples of such machine vision applications include 3D object inspection, including classification, anomaly detection, and/or segmentation.

A conventional deep learning model can include a chain of signal processing filters. Each filter can be applied in sequence to transform an input data structure into a desired output. For instance, the input could be a 2D image and the output could be a defect segmentation mask (e.g., for inspection applications), or a probability of the input belonging to a given category (e.g., for classification applications). These models can include convolution filters, which can be configured relatively easily and applied to uniformly spaced grids such as 2D images.

The input 2D image can be generated using various types of transformations and/or transformation configurations. In some embodiments, the input may be a 2D map. The 2D map may be configured to be compatible with the data format of 2D images such that the 2D map can be processed by a deep learning model. Given a particular transformation type, for example, the 3D data of an object surface in a scene could be transformed into a 2D map using the transformation type. The pixel values of the resulting 2D map may represent specific features of the surface. What features should be used for the projection is typically application dependent.

There are often many available transformation options, including combinations of parameters for each transformation type, which can result in many transformation options for transforming the 3D data of a scene into a 2D map. Example transformation types may include a height map with pixel values indicating the distance of object features from a reference plane, a normal map with pixel values representing the surface normal direction, a surface details map with pixel values indicating high frequency features, a curvature map to indicate the surface curvatures (e.g., mean and Gaussian), and an intensity image representing the illuminance appearance of objects. The parameters for each transformation type may include, for example, pixel size and kernel size used in surface normal and local surface estimation. Each parameter configuration may characterize a transformation option. In some embodiments, transformation type may refer to an operation of transforming 3D data of a scene into a 2D map, which may include the configurable parameters. In some embodiments, the transformation type can represent a configuration of parameters, such as at least one parameter. A transformation type may be identified by identifying at least one parameter.

With (many) different choices of transformation types and the combinations of the corresponding involved parameters for each transformation type, there can exist many options available to transform 3D data of a scene into a 2D image. However, typically just one transformation type and/or set of parameter configurations may be optimal for a particular application. Without prior knowledge, every possible transformation type could be tested to find the best one. This could be achieved, for example, for supervised learning in a brute force manner; where the selected model is trained on the training samples' 2D maps of each possible option and evaluated using the confidence measurement of the trained model. However, this could be time-consuming, and typically is only feasible off-line rather than when running for a run time application. For applications that require fast training on an embedded device to adapt at run time, such an approach is impractical, even if the number of training samples is limited.

The techniques described herein provide for an effective and efficient method of identifying a transformation type, such as a projection type, for applications such as 3D data-based classification, anomaly detection and segmentation. Rather than trying every possible transformation option to identify a transformation type as a best performing type, the techniques described herein perform statistical analysis over a set of training samples to identify a (preferred) transformation type. The statistical analysis can include histograms of pixel values. The techniques described herein can be less time-consuming than a brute force manner of trying every possible transformation option. The techniques described herein can also work on an embedded device, which is not possible for brute force techniques. The techniques described herein can provide accessibility to novice users. The techniques can also benefit experienced users since it can be difficult to select an optimum setup for a particular application.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

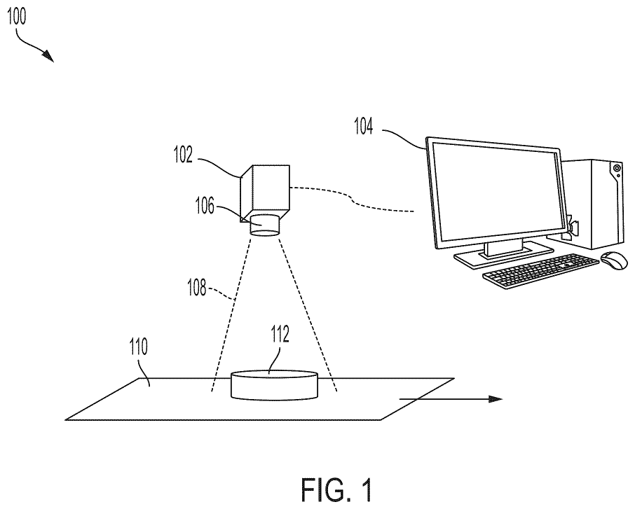

FIG. 1 shows an exemplary machine vision system 100, according to some embodiments. The exemplary machine vision system 100 includes a camera 102 (or other imaging acquisition device) and a computer 104. While only one camera 102 is shown in FIG. 1, it should be appreciated that a plurality of cameras can be used in the machine vision system (e.g., where a point cloud is merged from that of multiple cameras). The computer 104 includes one or more processors and a human-machine interface in the form of a computer display and optionally one or more input devices (e.g., a keyboard, a mouse, a track ball, etc.). The computer may include a non-transitory computer readable medium comprising program instructions. Camera 102 includes, among other components, a lens 106 and a camera sensor element (not illustrated). The lens 106 includes a field of view 108, and the lens 106 focuses light from the field of view 108 onto the sensor element. The sensor element generates a digital image of the camera field of view 108 and provides that image to a processor that forms part of computer 104. The sensor element can include at least one processor configured to perform one or more operations described herein. As shown in the example of FIG. 1, object 112 travels along a conveyor 110 into the field of view 108 of the camera 102. The camera 102 can generate one or more digital images of the object 112 while it is in the field of view 108 for processing, as discussed further herein. In operation, the conveyor can contain a plurality of objects. These objects can pass, in turn, within the field of view 108 of the camera 102, such as during an inspection process. As such, the camera 102 can acquire at least one image of each observed object 112.

In some embodiments, the camera 102 is a three-dimensional (3D) imaging device. As an example, the camera 102 can be a 3D sensor that scans a scene line-by-line, such as the In-Sight 3D-L4000 and/or the 3D-A1000 available from Cognex Corp., the assignee of the present application. According to some embodiments, the 3D imaging device can generate a set of (x, y, z) points (e.g., where the z axis adds a third dimension, such as a distance from the 3D imaging device). The 3D imaging device can use various 3D image generation techniques, such as shape-from-shading, sterco imaging, time of flight techniques, projector-based techniques, and/or other 3D generation technologies. In some embodiments the machine vision system 100 can also include a two-dimensional (2D) imaging device, such as a 2D CCD or CMOS imaging array. In some embodiments, two-dimensional imaging devices generate a 2D array of brightness values.

In some embodiments, the machine vision system processes the 3D data from the camera 102. The 3D data received from the camera 102 can include, for example, a point cloud and/or a range image. A point cloud can include a group of 3D points that are on or near the surface of a solid object. For example, the points may be presented in terms of their coordinates in a rectilinear or other coordinate system. In some embodiments, other information, such as a mesh or grid structure indicating which points are neighbors on the object's surface, may optionally also be present. In some embodiments, the 2D and/or 3D data may be obtained from a 2D and/or 3D sensor, from a CAD or other solid model, and/or by preprocessing range images, 2D images, and/or other images.

According to some embodiments, the group of 3D points can be a portion of a 3D point cloud within user specified regions of interest and/or include data specifying the region of interest in the 3D point cloud. For example, since a 3D point cloud can include so many points, it can be desirable to specify and/or define one or more regions of interest (e.g., to limit the space to which the techniques described herein are applied).

Examples of computer 104 can include, but are not limited to a single server computer, a series of server computers, a single personal computer, a series of personal computers, a mini computer, a mainframe computer, and/or a computing cloud. The various components of computer 104 can execute one or more operating systems, examples of which can include but are not limited to: Microsoft Windows Server™; Novell Netware™; Redhat Linux™, Unix, and/or a custom operating system, for example. The one or more processors of the computer 104 can be configured to process operations stored in memory connected to the one or more processors. The memory can include, but is not limited to, a hard disk drive; a flash drive, a tape drive; an optical drive; a RAID array; a random access memory (RAM); and a read-only memory (ROM).

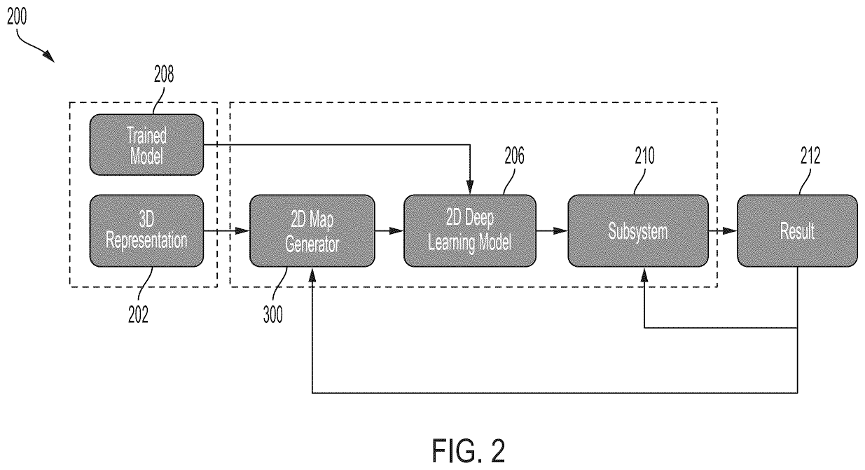

FIG. 2 is a block diagram of an exemplary system 200 for 3D inspection, according to some embodiments. According to some embodiments, the exemplary system 200 can be configured for a 3D inspection task such as a classification task and/or a segmentation task. For instance, the system 200 can be configured to inspect an object, or a scene with multiple objects, and provide an inspection result (e.g., report if defects are found or not), such that an operator and/or an automated system can take appropriate action(s) depending on the inspection result (e.g., to separate a defective part). The inspection tasks can vary from application to application. For example, some applications can be configured to identify cosmetic defects like dents and cracks. As another example, some applications can be configured to verify whether a part is correctly assembled (e.g., if all required screws are present and tight, or if bottles have their caps correctly placed).

The techniques described herein provide for leveraging pre-trained 2D deep learning models, which are trained using 2D images that are not related to the specific machine vision application, to process 3D representations. As a result, the techniques do not require developing customized 3D deep learning models for individual inspection tasks. As illustrated, the exemplary system 200 can include a 2D map generator 300, a 2D deep learning model 206, and an inspection subsystem 210. The 2D map generator 300 can receive a 3D representation 202 of a scene, such as 3D point clouds, meshes, voxel grids, etc., and transform the 3D representation 202 of the scene to a 2D map. The 2D map can be configured to be compatible with the data format of regular 2D images (e.g., grayscale or RGB images) such that the 2D map can be processed by the 2D deep learning model 206. In some embodiments, the 2D map can include clements disposed in a rectangular array.

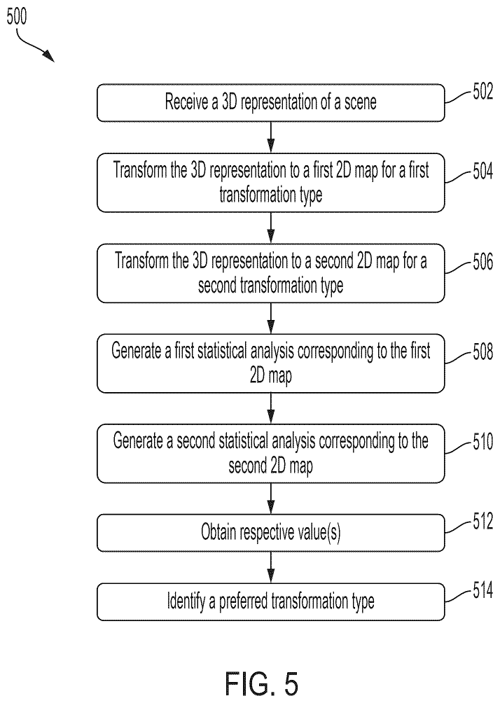

The 2D map generator may be configured to generate the 2D map as a 2D projection image based on optimal projection parameters. The transformation type, such as the projection type, and corresponding parameters may be obtained according to the techniques described herein (e.g., as described in relation to FIG. 5).

Each element of the 2D map can include a vector of one or more geometric features computed from the 3D representation 202 of the scene. Examples of geometric features include, but are not limited to, a distance of an associated 3D point of the 3D representation 202 to a reference, a surface normal vector of the associated 3D point, and a curvature associated with the 3D point. Examples of a reference include, but are not limited to, a point, a line, a plane, a hemisphere, a cylindrical surface, or a quadratic surface. In some embodiments, the number of geometric features in the vector can be in a range of one to three features, corresponding to the format of grayscale and/or RGB images. For example, when the number of geometric features in the vector is one, the 2D map can be configured corresponding to the format of a grayscale image; when the number of geometric features in the vector is two, a third channel of the vector can be set to zero or a suitable constant value such that the 2D map can be configured corresponding to the format of an RGB image; and when the number of geometric features in the vector is three, the 2D map can be configured corresponding to the format of an RGB image. In some embodiments, the geometric features in the vector can be determined/adjusted based on the inspection task that the system 200 is configured to perform. For example, the vector may include, for an object classification task, a distance of an associated 3D point of the 3D representation 202 to a reference and, for identifying a surface cosmetic defect, both the distance of the 3D point to the reference and a curvature associated with the 3D point.

The 2D deep learning model 206 can generate an output based on the 2D map and provide the output to the inspection subsystem 210 for generating an inspection result 212. The output of the 2D deep learning model 206 can include 2D information about the scene. In some embodiments, the 2D deep learning model 206 can include a model 208 pre-trained using regular 2D images that can be unrelated to the inspection tasks.

The inspection subsystem 210 can be configured to relate the 2D information about the scene in the output of the 2D deep learning model 206 to the 3D representation 202, and/or to filter the output of the 2D deep learning model 206 according to user defined criteria. For example, the inspection result 212 can be a category label for the inspected scene like “PASS” and “FAIL”, or it could be a segmentation mask indicating the 3D region where a defect has been found, with a corresponding classification label (e.g., “dent” or “crack”).

The 2D deep learning model 206 and/or the inspection subsystem 210 can be adapted according to the inspection task that the system 200 is configured to perform. An edge learning approach can be used to customize the 2D deep learning model 206 and/or the inspection subsystem 210, using a limited (small) set of 2D representations associated with the inspection task that the system 200 is configured for (e.g., 2D representations of good/bad components with corresponding labels for an inspection application). For example, five to ten 2D maps can be sufficient to customize the 2D deep learning model 206 and/or the inspection subsystem 210 for most inspection tasks. In some instances, one or two 2D maps can give reasonable results. For example, an edge learning approach can be used to customize the 2D deep learning model 206 and/or the inspection subsystem 210 to provide for each pixel labels that indicate, e.g., flaws (such as dents and/or scratches), regions determinations, and foreign object detections. As another example, an edge learning approach can be used to customize the 2D deep learning model 206 and/or the inspection subsystem 210 to recognize optical characters that can be in a variety of formats (e.g., direct part marking, hazard label text, rotated text). As a further example, an edge learning approach can be used to customize the 2D deep learning model 206 and/or the inspection subsystem 210 to robustly detect product instances (e.g., number of test tubes in a tray, number of empty spots in a tray).

In some embodiments, the 2D deep learning model 206 and/or the inspection subsystem 210 can include a component, such as a back-end component of and/or associated with the 2D deep learning model 206. The back-end component can be modified using 2D representations. The back-end component can maintain a plurality of adjustable parameters. The adjustable parameters can be adjusted based on the inspection result (e.g., inspection result 212 of the inspection subsystem 210) and/or a training set of 2D representations. The parameters can be determined according to the transformation type selected using the techniques described herein, such as in relation to FIG. 5.

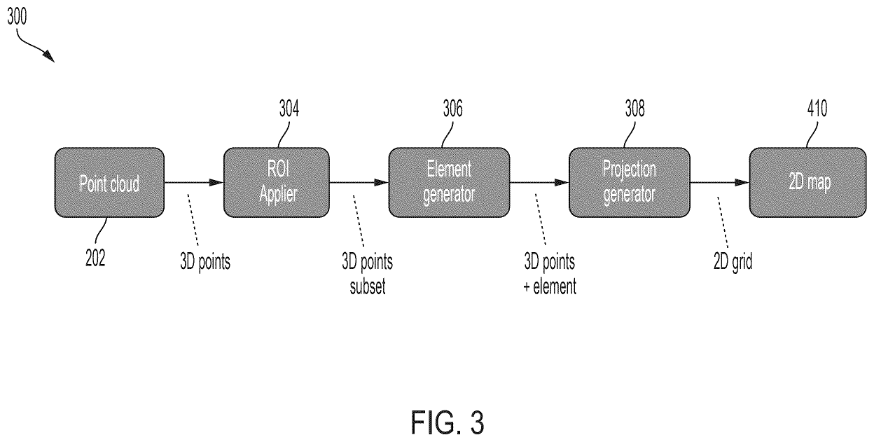

FIG. 3 is a block diagram of an exemplary 2D map generator 300 of the system 200 for 3D inspection, according to some embodiments. The 2D map generator 300 can include a region of interest (ROI) applier 304, an element generator 306, and a transformation generator, such as projection generator 308 shown in FIG. 3. The ROI applier 304 can receive the 3D representation 202 (illustrated as 3D point cloud as an example) and identify a subset of 3D points in the point cloud corresponding to an ROI. The ROI can be any 3D shape, such as a 3D box, a sphere, etc. Optionally, the ROI can be determined by a user of the system 200 for 3D inspection. For example, a user can select a portion of an object to inspect. For example, where a task can be to inspect the label on a bottle rather than the whole bottle, a user can create a ROI over the label and exclude the neck of the bottle. Localizing the inspection area can yield more accurate results.

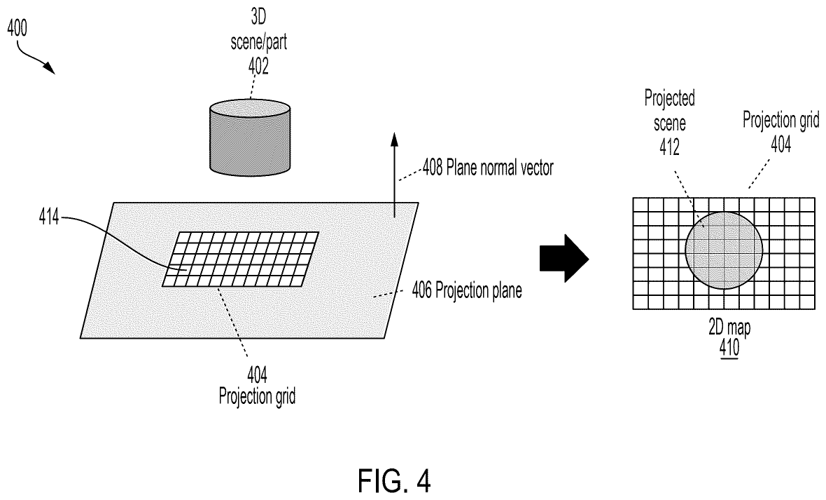

The element generator 306 can be configured to, for each of the subset of 3D points, compute the geometric features and determine, for each of the elements of the 2D map, the vector of the geometric features based on the computed geometric features of the subset of 3D point. As described above, examples of geometric features include, but are not limited to, a distance of an associated 3D point of the 3D representation 202 to a reference, a surface normal vector of the associated 3D point, and a curvature associated with the 3D point. Examples of a reference include, but are not limited to, a point, a line, a plane, a hemisphere, a cylindrical surface, or a quadratic surface. The projection generator 308 can include any suitable operation that projects the output of the element generator 306 (e.g., the subset of 3D points and the computed geometric features of the subset of 3D points) to the array of the 2D map. The projection generator 308 may project an image according to an optimal projection type as determined according to the techniques described herein. An exemplary processing 400 by a projection generator 308 of the 2D map generator 300 is described below with FIG. 4.

In some embodiments, multiple ROIs can be determined based on the inspection task and/or by a user of the system 200 so as to, for example, generate a combined 2D map. The multiple ROIs may or may not overlap. The combined 2D map can be generated by aggregating geometric features of the multiple ROIs, each of which can be represented in a local array, based on poses of the multiple ROIs. Such a configuration can be useful for some applications. For example, to represent a surface that spans a large space while having curvature variation in the spanned space, using one ROI could be challenging since surface feature extraction could be location and orientation dependent. With multiple ROIs, each ROI can provide an oriented focus view responsible for extracting a portion of the surface within the ROI. With multiple overlapped ROIs or a moving sequence of ROIs, a combined 2D map that contains all the surface details in a 2D format, which can be equivalent to a 3D representation of the surface (e.g., unwrapped/flattened), can be generated.

FIG. 4 is a schematic diagram illustrating an exemplary processing 400 by a projection generator 308 of the 2D map generator 300 to transform a 3D representation 402 (e.g., a 3D cloud) to a projected scene 412 in a 2D map 410. As illustrated, a discrete grid 404 is defined on an oriented projection plane 406 that has a plane normal vector 408. The projection generator 308 can map each 3D point (e.g., a 3D point p=(x,y,z) in a coordinate system of the 3D representation 402) to an element 414 in the grid 404 (e.g., an element q=(u,v) in the grid 404). The element 414 can include multiple 3D points that are adjacent to the 3D point p.

The projection generator 308 can generate the vector of geometric feature(s) for each element 414 in the grid 404. In some embodiments, the projection generator 308 is configured to, for each element 414 in the grid 404, generate the vector based on one of the multiple 3D points and discarding the rest of the multiple 3D points. For example, the projection generator 308 can be configured to, according to the inspection task that the system 200 is configured for, generate the vector based on the 3D point that has the highest value(s) for the geometric feature(s), the lowest value(s) for the geometric feature(s), or specific criteria such as a range of value(s) for the geometric feature(s). In some embodiments, the projection generator 308 can be configured to, for each element 414 in the grid 404, determine the vector of the geometric feature(s) based on the geometric feature(s) of all of the multiple 3D points (e.g., in the form of a weighted average). For example, each element 414 can store the Euclidean distance from the projected point(s) to the projection plane 406, a unit normal vector corresponding to the projected point(s), and/or the z-component of the unit surface normal vector.

The techniques described herein provide for statistical analysis-based identification of a preferred or optimal transformation type. As an example, projection autotune methods can be used to select a projection candidate from a plurality of available options.

As an illustrative example, the techniques can be used with a 3D image processing system. As described herein, training 3D image processing systems may include imaging sample parts, training the system using a set of 2D maps generated from the 3D images of the sample parts, and then performing run-time 3D image processing (e.g., classification, segmentation, etc.) using the trained system. A transformation type can be initially configured and/or selected to generate the 2D maps. As an illustrative example, for a segmentation application, a user may need to draw labels on the training images (e.g., using a user interface (UI) to label defects). For such an application, the transformation type needs to provide sufficient contrast to identify the defect to allow the user to properly draw the labels. Therefore, an initial transformation type may be chosen that provides sufficient identification of the defects. However, the system or the user may not know whether the initial transformation type is optimal. As a further example, for a classification application, the initial transformation type needs to sufficiently identify categories so that they can be labeled for training. As a result, the initial projection type needs to provide sufficient identification of the categories. However, like with the initial transformation type for the segmentation example, it may not be the optimal transformation type for categorization.

The techniques described herein can identify a recommended (e.g., preferred) transformation type. The techniques may confirm the initial or pre-configured transformation type, or may select or identify a different (better) transformation type. Once the 3D images are captured, the system can run the techniques described herein to identify a preferred or recommended transformation type. Identifying a preferred transformation type does not require training the 2D deep learning model used in the system, rather it only requires performing statistical analysis of the available transformation types as described herein.

As a result, the techniques can determine an optimal transformation type and then the system can be trained using the optimal transformation type. The preferred transformation type can represent a configuration of a set of features including at least one of height, normal vector, surface details, and curvature. The training process can include a re-labeling step with 2D maps transformed using the optimal transformation type. According to some embodiments, re-labeling a sample using a preferred transformation type may refine the labeling of training samples and may improve the training set quality. In some embodiments, the system may tune the transformation type automatically such that as an example, the optimal transformation type is set as the transformation type without additional user input. In other embodiments, the system may present the recommended transformation type to the user for the user to select the recommended transformation type if desired.

FIG. 5 is an exemplary flowchart illustrating a computerized method 500 for identifying a transformation type. According to some embodiments, the computerized method 500 of FIG. 5 may be performed for 3D image processing applications using a deep learning network to perform tasks such as classification, anomaly detection and/or segmentation of a 3D representation of a scene.

At step 502, a system (e.g., machine vision system 100 of FIG. 1) receives a 3D representation of a scene. According to some embodiments, the 3D representation of the scene is a training sample. The system may receive the training samples from a file or from storage, and/or may be configured to capture the training samples. Step 502 may involve obtaining more than one 3D representation of a scene. Multiple 3D representations of a same scene may be obtained and subsequently received by the system for the computerized method of FIG. 5. Multiple 3D representations of different scenes may be received, as the techniques are not so limited. The 3D representations may be a subset of a set of training samples for 3D image processing applications. The training samples may be a 3D point cloud that includes a plurality of 3D points. According to some embodiments, the training sample may be a 2D map that is generated according to a first transformation type. The 3D representation of the scene may be labeled, such as according to 3D points. The 2D map may be labeled. One sample, three or fewer samples, five or fewer samples, ten or fewer samples, twenty or fewer samples, or thirty or fewer samples may be received, as the techniques are not so limited. The 3D representation received may be a portion of an entire 3D representation, such as a 3D representation corresponding to a particular object in a scene. The entire 3D representation may be used for inspection applications, including anomaly detection and/or classification applications.

At step 504, the system transforms the 3D representation to a first 2D map for a first transformation type. The 2D map may be derived from 3D data of the 3D representation. According to some embodiments, the 2D map may have been transformed prior to the start of the computerized method 500, and the system may receive the 2D map instead of a 3D representation. In the case that the 3D representation is transformed by the system performing method 500, the system may select the first transformation type from multiple options of transformation types. The first transformation type may be a type for which a 2D map has not been derived from at the time of performing step 504. There may be a multiple available transformation types, such as five transformation types (e.g., such as projection types) to choose from, five to ten transformation types to choose from, more than ten transformation types to choose from, and so on, as the techniques are not so limited. As discussed herein, the transformation type can represent a configuration of features such as height, normal vector, surface details, and curvature. Example transformation types may include a height map, a normal map, a surface details map, a curvature map, and an intensity image.

At step 506, the system transforms the 3D representation to a second 2D map for a second transformation type. The second transformation type may be a type for which a 2D map has not been derived from at the time of performing step 506. According to some embodiments, the portion of the 3D representation that is transformed to the second 2D map is the same portion, such as the entire 3D representation, transformed in step 504. Alternatively, or additionally, the portion of the 3D representation that is transformed to the second 2D map may be a different portion. For example, the first 2D map may correspond to a first object in a scene and the second 2D map may correspond to a second object in the scene.

Following each of steps 504 and/or 506 or following both of steps 504 and 506, the 2D maps may be labeled. The 2D maps may be labeled by a user. In some embodiments, the 2D maps are labeled according to a category. In some embodiments, the 2D maps are labeled per region, such as for segmentation applications. In cases in which the 2D maps are labeled per region, the labeling may correspond to an associated category. The training sample for the 3D image processing applications may include the 3D representation and the corresponding transformed 2D map. If there are multiple 3D representations, or portions of a same 3D representation, there may be multiple training samples. The training samples may be labeled only for a first transformation type, and the system may use the first transformation type labels when processing subsequent 2D maps. In some embodiments, a training sample may be labeled with multiple training labels.

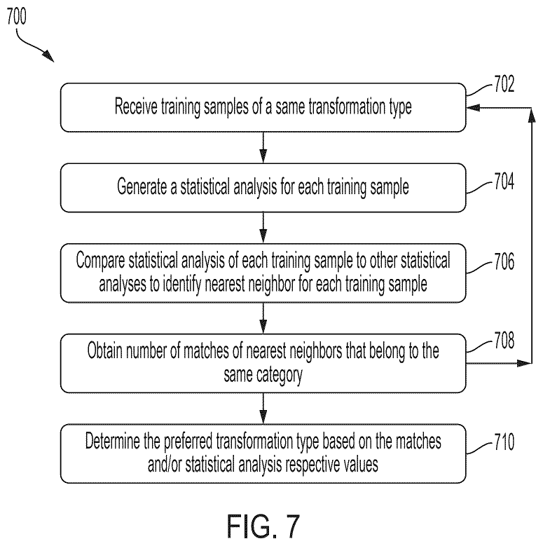

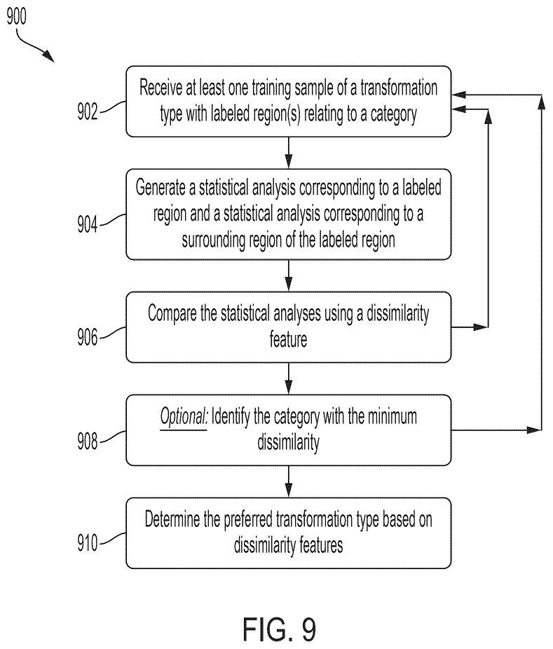

At step 508, the system generates a first statistical analysis corresponding to the first 2D map. The statistical analysis may correspond to at least a portion of the first 2D map. The statistical analysis may correspond to the entire map of the first 2D map. The statistical analysis of step 508 may result in a respective value. The statistical analysis of step 508 may be a histogram. In the case of a histogram-based statistical analysis, the respective value can be a distance. In some embodiments, a pixel value of the 2D map may correspond to a geometric feature calculated according to the projection type (e.g., intensity, height). The pixel value may range from 0 to 255 (e.g., corresponding to 256 pixel value options). In the case of a histogram, the histogram counts occurrences of the pixel values. The bins for the pixel value may range from 0 to 255. Once the histogram is obtained, a statistic can be calculated using the histogram to determine the predicted effectiveness of 3D image processing using a particular transformation type (e.g., as described in relation to FIGS. 7 and 9).

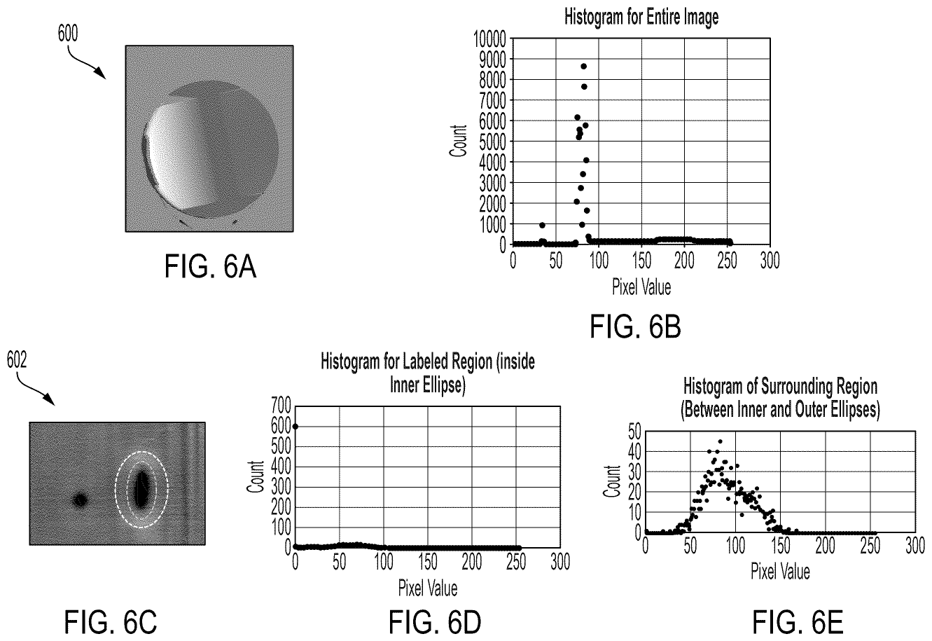

In some embodiments, the first statistical analysis may include a histogram of derived features of a transformed 2D map. The derived features may be obtained from an output of the first few layers of a pre-trained neural network on the 2D map. The derived features may be obtained from other artificial intelligence (AI) methods. The first statistical analysis may include a histogram of pixel values (e.g., as described in relation to FIGS. 6A-6E). The first statistical analysis may use statistical techniques including pixel values, local contrast, their spatial distributions in a scene, and characteristic of the images in the frequency domain (e.g., response of specific filters).

At step 510, the system generates a second statistical analysis corresponding to the second 2D map. The second statistical analysis may correspond to at least a portion of the second 2D map. The statistical analysis of step 510 may result in a respective value. The statistical analysis of step 510 may be a histogram. As such, different histograms may be obtained for different samples. Different histograms may also be obtained for different projection types.

In some embodiments, the statistical analyses of steps 508 and 510 may be analyzed together, resulting in a single respective value. The statistical analysis corresponding to the 2D maps may be part of another statistical analysis. In the case of the statistical analyses being histograms, a comparison of the histograms may result in an additional statistical analysis providing a single value. In some embodiments, the statistical analyses of steps 508 and 510 may be analyzed separately and may result in separate values. The statistical analysis may include obtaining a dissimilarity feature and/or a similarity metric. A dissimilarity feature may be obtained using a distance value. A similarity feature may include the dot product of normalized histogram frequencies.

At step 512, the system obtains respective values. These respective values may be obtained from results of each statistical analysis. The respective values may be obtained by analyzing the first and second statistical analysis. Alternatively, a single respective value may be obtained at step 512. In some embodiments, the respective values may be a distance, such as when the statistical analysis is a histogram (e.g., as described in relation to FIGS. 7 and 9).

At step 514, the system identifies a preferred transformation type. The preferred transformation type may be the first transformation type, second transformation type, or another transformation type. The preferred transformation type may be selected based at least in part on the respective values. As an example, the preferred transformation type may be selected based on a minimum distance.

Other transformation types may have been analyzed in the statistical analysis corresponding to the first 2D map or second 2D map to obtain the preferred transformation type. Steps 502-512 may be repeated for the other transformation types. Repeating the steps may include repeating each step or repeating some steps, such as repeating steps 504-512. Steps 502-512 may be repeated for additional 3D representations, such as a second, third, and fourth 3D representation. The additional iterations of the steps of computerized method 500 may therefore be performed for each transformation type of the options and/or for one or more additional 3D representations. The additional 3D representations may be of the same scene as the 3D representation of a first iteration of step 502. The additional 3D representations may be of a different scene than the 3D representation of a first iteration of step 502. The additional 3D representations may be within a same category as or a different category than the 3D representation of a first iteration of step 502. There may be more than ten representations, ten or fewer 3D representations, five or fewer 3D representations, or two 3D representations.

In some embodiments, analyzing the statistical analyses can include comparing statistical analyses for different iterations of method 500. For example, the analysis can include comparing each statistical analysis of a first 3D representation to that of a second 3D representation.

Depending on the nature of a transformation, or projection, the 2D map may have one channel (e.g., a grayscale image) or the 2D map may have more than one channel. When computing a histogram for a 2D map represented as an image, determining the counts of pixels (e.g., binning) may be based on a vector of image pixel values. In some embodiments, the elements of the vector may correspond to a pixel value of a corresponding channel. Alternatively, in some embodiments, an image including multiple channels as a unified image may be computed by combining the elements of each channel for a pixel into a single value. For a unified image, a histogram may be computed using the combined pixel value instead of individual channel values. In some embodiments, the histogram may be created using each channel of an image separately. The histograms may then be concatenated into a single overall histogram. Generating a statistical analysis can include determining the counts of pixels within a series of bins per each channel of a 2D map, or determining the counts of pixels within the series of bins per a combined channel with two or more channels of the 2D map.

The acts performed as part of the computerized method 500 may be ordered in any suitable way. Accordingly, embodiments may be constructed in which acts are performed in an order different than illustrated, which may include performing some acts simultaneously, even though shown as sequential acts in illustrative embodiments. There may be additional acts or fewer acts performed as part of the method as well.

FIG. 6A shows an example 2D projection image 600 of an object with two lids. The 2D projection image 600 may be a training sample, according to the techniques described herein.

FIG. 6B shows a histogram for the 2D projection image 600 of FIG. 6A, according to some embodiments. As shown in FIG. 6B, the histogram counts occurrences of the pixel values in the 2D projection image 600. The histogram may have a count of pixels that are within a series of bins that each have an associated range of pixels, as shown. The histogram may be used to obtain a distance, such as described in relation to FIG. 7.

FIG. 6C is a labeled 2D projection image 602 of an object. The labeled 2D projection image 602 may be a training sample, according to the techniques described herein.

FIG. 6D is a histogram for the labeled 2D projection image 602 of FIG. 6C, according to some embodiments. As shown in FIG. 6D, the histogram counts occurrences of the pixel values in the labeled 2D projection image 602 for the labeled region (inside the inner ellipse). The histogram of FIG. 6D may be used to obtain a distance, such as described in relation to FIG. 9.

FIG. 6E is another histogram for the labeled 2D projection image 602 of FIG. 6C, according to some embodiments. As shown in FIG. 6E, the histogram counts occurrences of the pixel values of the surrounding region (between the inner and outer ellipses) in the labeled 2D projection image 602. The histogram of FIG. 6E may be used to obtain a distance, such as described in relation to FIG. 9.

FIG. 7 is an exemplary flowchart illustrating a computerized method 700 for determining a transformation type. According to some embodiments, the computerized method of FIG. 7 may be performed for classification applications. According to some embodiments, the computerized method of FIG. 7 may be performed for anomaly detection (e.g., whether an abnormality is present or not) applications. At step 702, a system (e.g., machine vision system 100 of FIG. 1) receives training samples of a same transformation type. According to some embodiments, the training samples may be a 3D point cloud that includes a plurality of 3D points. According to some embodiments, the training sample may be a 2D map that is generated according to a first transformation type. According to some embodiments, the training sample may be a 2D image that is generated according to a first projection type. The training samples may be obtained as described in relation to FIG. 5.

At step 704, the system generates a statistical analysis for each training sample. The statistical analysis may be, for example, a histogram that may have a count of pixels that are within a series of bins that each have an associated range of pixel values.

At step 706, the system compares the statistical analysis of each training sample to other statistical analyses to identify the nearest neighbor for each training sample using a respective value. The respective values may be used to obtain a sum of the values over all samples. The respective value may be a distance, such as when the statistical analysis is a histogram. The distance may be determined to measure the difference of two 2D maps to find the nearest neighbor (e.g., the two samples with the smallest distance between them). The distance may be measured using the standard deviation σ_{A} and mean μ_{A} of the histogram. According to some embodiments, the distance d between a first 2D map “1” and a second 2D map “2” can be calculated according to the following equation:

$$d = \frac{\vert {μ}_{1} - {μ}_{2} \vert}{\sqrt{{σ}_{1} * {σ}_{2} + 1 e - 9}}$$

In some embodiments, for each sample (e.g., a first 2D map “1”), a nearest neighbor (e.g., second 2D map “2”) can be identified by finding the smallest distance among the calculations of distance. For example, the first 2D map “1” may have a distance calculation with the second 2D map “2” and there may be a distance calculation with a third 2D map “3.” In the case of three 2D maps, as an example, each training sample would have two corresponding distances. The distance calculation that is smallest is used to identify the nearest neighbor for the first 2D map “1” (e.g., one distance is selected to identify the nearest neighbor). In some embodiments, identifying the nearest neighbor may include determining a normalized Gaussian distance between two statistical analyses, such as two histograms of a same transformation type. Each nearest neighbor thereby corresponds to a distance calculation, and the sum of these minimum distances can be obtained over all samples.

At step 708, the system obtains the number of matches of nearest neighbors that belong to the same category. If the nearest neighbors are of a same category, a category match can be identified. Since some samples may be of a different category, there may be no matches obtained. Once each sample has its nearest sample identified, the total number of category matches can be obtained.

As shown in FIG. 7, the computerized method 700 may repeat steps 702-708. The method may repeat these steps for different transformation types. As an example, if steps 702-708 are performed by the system for a first transformation type, the system could store category matches and the calculated sum of the obtained values over all samples for that first transformation type. The system could then perform steps 702-708 for a second transformation type to obtain a second set of category matches and a sum of the obtained values over all samples for that second transformation type. The system may repeat steps 702-708 for five transformation types, seven transformation types, or ten transformation types, as the techniques are not so limited.

At step 710, the system determines the preferred transformation type based on the matches and/or statistical analysis respective values. The system may consider the results for each transformation type as obtained through repeating steps 702-708. The optimal transformation candidate may be chosen by selecting the transformation type that has the maximum number of matches. This result corresponds to the maximum consistency within each category. Without wishing to be bound by theory, the transformation type with the maximum consistency can be predicted to perform better compared to other transformation types since samples of a same category may be similar for particular parameters of a transformation while samples in another category may be similar. Analyzing the statistical analyses can include using criteria such as the consistency among training samples within each category.

Alternatively, or additionally, analyzing the statistical analyses can include using criteria including a distance between each training sample and a nearest neighbor of the sample. In some embodiments, the transformation type with a minimum sum of the minimum respective values, such as distances, may be selected. The minimum sum may be used when more than one transformation type have the same maximum number of matches. When the overall respective value between each sample and its nearest neighbor is minimized, the selected transformation type may result in more effective classification relative to the other transformation types.

The acts performed as part of the computerized method 700 may be ordered in any suitable way. Accordingly, embodiments may be constructed in which acts are performed in an order different than illustrated, which may include performing some acts simultaneously, even though shown as sequential acts in illustrative embodiments. There may be additional acts or fewer acts performed as part of the method as well.

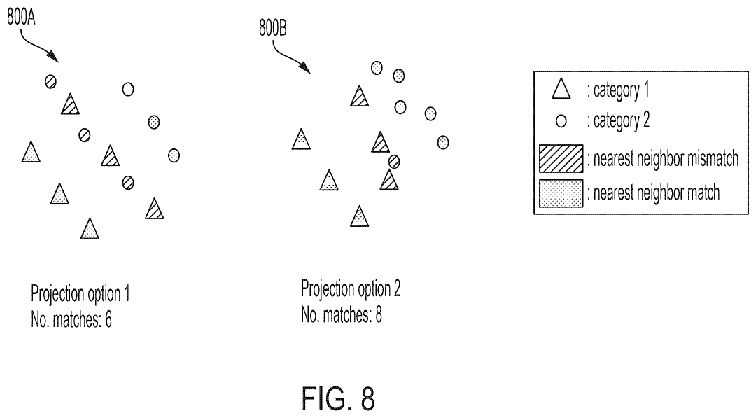

FIG. 8 illustrates an example of comparison results for classification and/or anomaly detection, according to some embodiments. Without wishing to be bound by theory, the samples that can be categorized into one classification category may have a similarity of at least one feature with other samples in that same category while samples in another category have similarity in features with other samples in that other category. As shown in FIG. 8, diagram 800A depicts samples that can be categorized into “category 1” (e.g., the triangles) and samples that fall into “category 2” (e.g., the ovals). Diagram 800A provides the result of obtaining a count of category matches for a first transformation option (e.g., as described in relation to step 708 of FIG. 7). Diagram 800A further illustrates the nearest neighbor matches and the nearest neighbor mismatches. In diagram 800A, “category 1” has three nearest neighbor mismatches and three nearest neighbor matches. Also referring to diagram 800A, “category 2” has three nearest neighbor mismatches and three nearest neighbor matches. Overall, diagram 800A shows six category matches.

As additionally shown in FIG. 8, diagram 800B depicts samples falling into “category 1” and samples that can be categorized into “category 2.” Diagram 800B provides the result of obtaining a count of category matches for a second transformation option (e.g., a second iteration of step 708 of FIG. 7). Diagram 800B further illustrates the nearest neighbor matches and the nearest neighbor mismatches. In diagram 800B, “category 1” has three nearest neighbor mismatches and three nearest neighbor matches. Also referring to diagram 800B, “category 2” has one nearest neighbor mismatch and five nearest neighbor matches. Overall, diagram 800B shows eight category matches.

The diagrams 800A and 800B of FIG. 8 provide a visual representation of two different iterations of step 708 shown in FIG. 7. It should be appreciated that this is for illustrative purposes, and the computerized method of FIG. 7 may not include a step of generating such diagrams, as these diagrams are solely intended to be a visual representation of the category matching process that may occur.

FIG. 9 is an exemplary flowchart illustrating a computerized method 900 for determining a transformation type. According to some embodiments, the computerized method of FIG. 9 may be performed for segmentation applications. At step 902, a system (e.g., machine vision system 100 of FIG. 1) receives at least one training sample of a transformation type with labeled regions relating to a category. As an example, the labeled region may correspond to a category of dents, or the labeled region may correspond to a category of bumps. According to some embodiments, the training samples may be a 3D representation. The samples may be a 3D point cloud that includes a plurality of 3D points. The 3D representation may include multiple 3D representation portions, such as different portions within different categories or different portions corresponding to different labeled regions. As an example, the 3D representation may include a first 3D representation portion within a first category and a second 3D representation portion within a second category. According to some embodiments, the training sample may be a 2D map that is generated according to a first transformation type. The training samples may be obtained as described in relation to FIG. 5. The samples may be of a same category. The samples may be of a different category. A portion of the 2D map may correspond to a portion of the 3D representation.

At step 904, the system generates a statistical analysis corresponding to the labeled regions and a statistical analysis corresponding to surrounding regions of the labeled regions. The statistical analysis may include a labeled statistical analysis corresponding to a labeled region of a training sample and a surrounding statistical analysis corresponding to an area surrounding the labeled region of the training sample. Each labeled region may correspond to a pair of statistical analyses. The statistical analysis may correspond to each labeled region of a same category of a 2D map, such as a projection image. The statistical analysis may be a histogram. In some embodiments, each histogram may have a count of pixels that are within a series of bins that each have an associated range of pixel values. Without wishing to be bound by theory, identifying the extent to which the background is discernable from the marked area can serve as an indicator of the effectiveness of a particular transformation type for segmentation applications. The statistical analysis results can provide quantitative measures of contrast for the region of interest and its surrounding region.

At step 906, the system compares the statistical analysis of each region type (e.g., labeled and surrounding) to obtain a dissimilarity feature. According to some embodiments, the dissimilarity feature is a distance. The distance d can be calculated according to 1.0 minus the dot product of the normalized histogram frequencies. Without wishing to be bound by theory, the distance can provide a measure of contrast between the two histograms. Since there may be more than one region included in the 2D map, there may be more than one pair of histogram calculations (e.g., multiple pairs of histograms), for each category. The distance value for each pair may be weighted based on the size of the respective region (e.g., the number of pixels within the region). In some embodiments, the larger the region is, the larger the weight for that region may be. Alternatively, or additionally, the system may obtain a similarity feature, such as the dot product of normalized histogram frequencies.

As shown in FIG. 9, the computerized method 900 may optionally repeat steps 902-906. The method may repeat these steps for different categories. As an example, if steps 902-906 are performed by the system for a first category (e.g., bumps), the system could store the dissimilarity features, such as including weighted distances, for the first category. The system could then perform steps 902-906 for a second category to obtain a second set of dissimilarity features. As an example, the system may obtain a third statistical analysis, such as for the second category. In some embodiments, the third statistical analysis may correspond to another portion of the training sample. The third statistical analysis may correspond to a different training sample. According to some embodiments, the third statistical analysis may be compared to a statistical analysis from a different iteration of the steps.

The system may repeat steps 902-906 for one category or for more than one category, as the techniques are not so limited. In subsequent iterations, step 902 may include receiving at least one training sample of the same transformation type of the same 2D map as the first iteration, but the sample may have different labeled regions corresponding to a different category and may therefore be a different labeled mask map.

In the case that steps 902-906 are not repeated for one or more other categories, the computerized method 900 may repeat steps 902-906 for different transformation types. As an example, if steps 902-906 are performed by the system for a first transformation type, the system could store the dissimilarity feature for the first transformation type. The dissimilarity feature for the first transformation type, in the case of one category, may be obtained by computing the average dissimilarity feature for the category. As an example, the average distance may be calculated using the distance sum for the category divided by the number of regions. The distance sum for the category may be obtained using the weighted distances as obtained based on the size of the region. The average dissimilarity feature may be selected as the representative distance measurement for the transformation option.

The system could then perform steps 902-906 for a second transformation type to obtain a representative dissimilarity measurement for that second transformation type. The system may repeat steps 902-906 for five transformation types, seven transformation types, or ten transformation types, as the techniques are not so limited.

Optionally, at step 908, in the case of more than one category, the system identifies the category with the minimum dissimilarity feature. The statistical analysis may include analyzing the difference between labeled statistical analysis and surrounding statistical analysis. The difference between the labeled statistical analysis and surrounding statistical analysis may be measured using a dissimilarity feature. The dissimilarity feature may include a distance between two corresponding statistical analyses.

Selecting one category may be based on the comparison for each region and/or the comparison for each transformation type. The comparison of statistical analyses, in some embodiments, can include comparing the analysis of two 2D maps derived from a first 3D representation of a first category to analysis of two 2D maps derived from a second 3D representation of a second category for a first and second transformation type such that analysis of a 2D map of a first transformation type and first category is compared to analysis of a 2D map of the first transformation type and second category, and analysis of a 2D map of a second transformation type and first category is compared to analysis of a 2D map of the second transformation type and second category.

The dissimilarity feature for the category may be obtained by computing the average for the respective category. As an example, the average distance may be calculated using the distance sum for each category divided by the number of regions. The distance sum for each category may be obtained using the weighted distances as obtained based on the size of the region. The minimum dissimilarity feature may be the minimum average dissimilarity feature. The minimum average feature may correspond with the category whose labeled regions and their surrounding areas have the minimum difference. The minimum average feature may be selected as the representative feature measurement for the transformation option.

As shown in FIG. 9, the computerized method 900 may repeat steps 902-908. The method may repeat these steps for different transformation types. As an example, if steps 902-908 are performed by the system for a first transformation type, the system could store the feature for the first transformation type. The system could then perform steps 902-908 for a second transformation type to obtain a feature for that second transformation type. The system may repeat steps 902-908 for five transformation types, seven transformation types, or ten transformation types, as the techniques are not so limited. The statistical analysis of a second transformation type may include a second labeled statistical analysis corresponding to a second labeled region and a second surrounding statistical analysis corresponding to an area surrounding the second labeled region. As an example, the system may obtain a fourth statistical analysis, such as for a second category. In some embodiments, the fourth statistical analysis may correspond to another portion of the training sample. The fourth statistical analysis may correspond to a different training sample. According to some embodiments, the fourth statistical analysis may be compared to a statistical analysis from a different iteration of the steps.

At step 910, the system determines the preferred transformation type based on the dissimilarity features. The system may consider the results for each transformation type as obtained through repeating steps 902-908. The optimal transformation candidate may be chosen by selecting the transformation type that has the maximum representative feature measurement. This result corresponds to the maximum contrast among transformation types. For example, when the distance is the maximum, the selected transformation type may result in more effective segmentation relative to the other transformation types. The statistical analysis used in this determination may include analyzing the difference between the labeled statistical analysis and surrounding statistical analysis.

Without wishing to be bound by theory, in the case of more than one category, by first identifying the category with the minimum contrast to use the average dissimilarity feature as the representative feature measurement, the system can account for predicted lowest performance resulting from low contrast. By second identifying the transformation type with the maximum contrast using the representative feature measurement, the system can predict a best performing transformation type even for the worst case of contrast for segmentation applications.

The acts performed as part of the computerized method 900 may be ordered in any suitable way. Accordingly, embodiments may be constructed in which acts are performed in an order different than illustrated, which may include performing some acts simultaneously, even though shown as sequential acts in illustrative embodiments. There may be additional acts or fewer acts performed as part of the method as well.

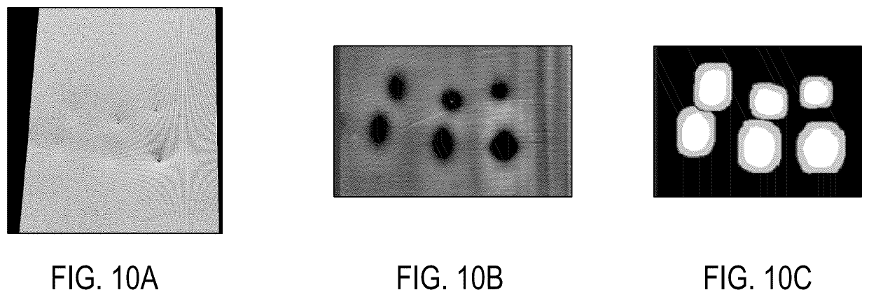

An exemplary segmentation task is shown in FIGS. 10A-10C. In this example, the task is to identify defects on a target object. As illustrated, FIG. 10A is a 3D point cloud of a battery surface. FIG. 10B is a 2D map of the battery surface, which can be provided by a 2D map generator (e.g., the 2D map generator 300 of FIG. 3). FIG. 10C is a labeled mask image that can be generated based on the 2D map shown in FIG. 10B, according to some embodiments. The labeled mask image can be used as a training sample, such as for the computerized method 900 of FIG. 9. In FIG. 10C, the labeled region corresponds to the inner, bright pixels while the surrounding region corresponds to the grey pixels located around the bright pixels. In the example of FIG. 10C, the labeled regions correspond to blobs. The blobs may correspond to a particular category of the segmentation. There may be one mask image per category. As an example, each training sample may have a plurality of labeled mask images corresponding to each involved category which offers one mask image. In some embodiments, the categories may be dents and bumps.

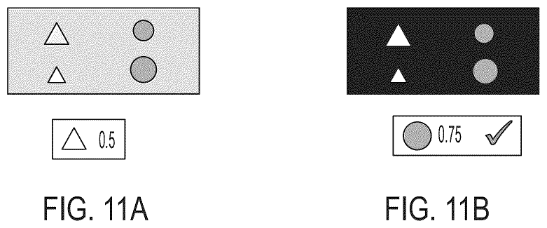

FIG. 11A is an exemplary projection option, according to some embodiments. As shown in FIG. 11A, a first category may be pictorially represented by triangles and a second category may be pictorially represented by circles. In FIG. 11A, the category with the minimum average distance is the category corresponding to the triangles with a value of 0.5.

FIG. 11B is another exemplary projection option for the same auto selection process of FIG. 11A, according to some embodiments. As shown in FIG. 11B, consistent with FIG. 11A, a first category may be pictorially represented by triangles and a second category may be pictorially represented by circles. In FIG. 11B, the category with the minimum average distance is the circles with a value of 0.75.

In accordance with the computerized method shown in FIG. 9, after identifying the category with the minimum average distance (e.g., step 908), the preferred projection type can be determined based on the distances (e.g., step 910). In the case of FIGS. 11A and 11B, for the first projection option (e.g., corresponding to FIG. 11A), the category with the minimum average distance is the triangles, and for the second projection option (e.g., corresponding to FIG. 11B), the category with the minimum average distance is the circles. In this example, the distances of 0.5 and 0.75 are then compared to determine that the representative distance of 0.75 is maximum. Accordingly, the projection autotune method proceeds to select the second projection option (e.g., corresponding to FIG. 11B), as indicated by the checkmark in FIG. 11B.

Techniques operating according to the principles described herein may be implemented in any suitable manner. The processing and decision blocks of the diagrams above represent steps and acts that may be included in algorithms that carry out these various processes. Algorithms derived from these processes may be implemented as software integrated with and directing the operation of one or more single-or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the diagrams included herein do not depict the syntax or operation of any particular circuit or of any particular programming language or type of programming language. Rather, the diagrams illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each diagram is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Various aspects are described in this disclosure, which include, but are not limited to, the following aspects:

1. A method for identifying a preferred transformation type of three-dimensional (3D) data for an image processing application using two-dimensional (2D) maps derived from 3D data, the method comprising: receiving a 3D representation of a scene; (b) transforming the 3D representation of the scene to a first 2D map for a first transformation type; (c) transforming the 3D representation of the scene to a second 2D map for a second transformation type; (d) generating a first statistical analysis corresponding to at least a portion of the first 2D map; (c) generating a second statistical analysis corresponding to at least a portion of the second 2D map; (f) obtaining respective values by analyzing the first statistical analysis and the second statistical analysis; and (g) identifying a preferred transformation type from the first and second transformation types based at least in part on the respective values.

2. The method of aspect 1, wherein at least one of the first statistical analysis or the second statistical analysis comprises a histogram.

3. The method of aspect 1 or aspect 2, wherein the first statistical analysis and second statistical analysis each comprise a count of pixels that are within a series of bins that each have an associated range of pixel values.

4. The method of aspect 3, wherein generating the first statistical analysis further comprises determining the counts of pixels that are within the series of bins per each channel of the first 2D map, or determining the counts of the pixels that are within the series of bins per a combined channel comprising two or more channels of the first 2D map.

5. The method of any of aspects 1 to 4, wherein the respective values each comprise a distance.

6. The method of any of aspects 1 to 5, wherein the 3D representation of the scene includes at least one of a point cloud, a mesh, or a voxel grid.

7. The method of any of aspects 1 to 6, wherein the preferred transformation type represents a configuration of a set of features including at least one of height, normal vector, surface details, and curvature.

8. The method of any of aspects 1 to 7, wherein the image processing application comprises using a deep learning network to perform classification, anomaly detection, and/or segmentation of the 3D representation of the scene.

9. The method of any of aspects 1 to 8, wherein the image processing application comprises using a 2D deep learning model that was pre-trained using a set of 2D images.

10. The method of any of aspects 1 to 9, wherein the first statistical analysis corresponds to the entire map of the first 2D map.

11. The method of any of aspects 1 to 10, wherein the 3D representation is a first 3D representation, the method further comprising: receiving a second 3D representation; and repeating steps (b)-(f) for the second 3D representation.

12. The method of aspect 11, wherein the second 3D representation is of the scene.

13. The method of aspect 11, wherein the second 3D representation is of a different scene.

14. The method of aspect 11, wherein: the first 3D representation is within a first category, the second 3D representation is within a second category, and the method further comprises: receiving a third 3D representation within the first category, repeating steps (b)-(f) for the third 3D representation, receiving a fourth 3D representation within the second category, and repeating steps (b)-(f) for the fourth 3D representation.

15. The method of aspect 14, wherein analyzing the statistical analyses comprises using criteria, including: a consistency among training samples within each category of a plurality of categories including the first and second category; or a distance between each training sample and a nearest neighbor of the training sample, wherein the training samples include the 2D maps derived from the first 3D representation, the second 3D representation, the third 3D representation, and the fourth 3D representation.

16. The method of aspect 11, wherein analyzing the first statistical analysis and the second statistical analysis to obtain the respective values comprises: comparing the first statistical analysis of the first 3D representation to the first statistical analysis of the second 3D representation; and comparing the second statistical analysis of the first 3D representation to the second statistical analysis of the second 3D representation.

17. The method of aspect 14, further comprising identifying the nearest neighbor for each training sample.

18. The method of aspect 17, wherein identifying the nearest neighbor includes determining a normalized Gaussian distance between two statistical analyses of a same transformation type.

19. The method of aspect 1 or any other preceding aspect, wherein the first statistical analysis comprises: a labeled statistical analysis corresponding to a labeled region of a training sample, the training sample including the first 2D map; and a surrounding statistical analysis corresponding to an area surrounding the labeled region of the training sample.

20. The method of aspect 19, wherein the first statistical analysis comprises analyzing a difference between the labeled statistical analysis and the surrounding statistical analysis.

21. The method of aspect 20, further comprising measuring the difference between the labeled statistical analysis and the surrounding statistical analysis using a dissimilarity feature.

22. The method of aspect 21, wherein the dissimilarity feature comprises a distance between two corresponding statistical analyses.

23. The method of aspect 19, wherein: the 3D representation includes a first 3D representation portion within a first category, the at least a portion of the first 2D map and the at least a portion of the second 2D map correspond to the first 3D representation portion, the second statistical analysis comprises: a second labeled statistical analysis corresponding to a second labeled region of a second training sample, the second training sample including the second 2D map; and a second surrounding statistical analysis corresponding to an area surrounding the second labeled region of the second training sample, and the method further comprises: receiving a second 3D representation within a second category and repeating steps (b)-(f) for the second 3D representation, and/or generating a third statistical analysis corresponding to at least a second portion of the first 2D map and generating a fourth statistical analysis corresponding to at least a second portion of the second 2D map, wherein the second portions correspond to a second 3D representation portion within a second category of the 3D representation.

24. The method of aspect 23, wherein the first statistical analysis and the second statistical analysis of the first 3D representation portion are compared to: the first and second statistical analysis of the 2D map of the second 3D representation, respectively, and/or the third and fourth statistical analysis.

25. The method of aspect 24, further comprising selecting the first category or the second category based on the comparison for each of the first transformation type and second transformation type.

26. The method of aspect 25, further comprising selecting the first transformation type or second transformation type based at least in part on a dissimilarity feature.

27. The method of aspect 1, wherein the first statistical analysis corresponds to each labeled region of a same category of the first 2D map.

28. A system comprising at least one processor configured to perform one or more operations in any of aspects 1-27.

29. A non-transitory computer readable medium comprising program instructions that, when executed, cause at least one processor to perform one or more operations in any of aspects 1-27.

It should be understood that the above-described acts of the methods described herein can be executed or performed in any order or sequence not limited to the order and sequence shown and described. Also, some of the above acts of the methods described herein can be executed or performed substantially simultaneously where appropriate or in parallel to reduce latency and processing times.

All definitions, as defined and used, should be understood to control over dictionary definitions, definitions in documents incorporated by reference, and/or ordinary meanings of the defined terms.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple clements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A method for identifying a preferred transformation type of three-dimensional (3D) data for an image processing application using two-dimensional (2D) maps derived from 3D data, the method comprising:
(a) receiving a 3D representation of a scene;
(b) transforming the 3D representation of the scene to a first 2D map for a first transformation type;
(c) transforming the 3D representation of the scene to a second 2D map for a second transformation type;
(d) generating a first statistical analysis corresponding to at least a portion of the first 2D map;
(e) generating a second statistical analysis corresponding to at least a portion of the second 2D map;
(f) obtaining respective values by analyzing the first statistical analysis and the second statistical analysis; and
(g) identifying a preferred transformation type from the first and second transformation types based at least in part on the respective values.

2. The method of claim 1, wherein at least one of the first statistical analysis or the second statistical analysis comprises a histogram and/or wherein the first statistical analysis and second statistical analysis each comprise a count of pixels that are within a series of bins that each have an associated range of pixel values.

3. (canceled)

4. The method of claim 2, wherein generating the first statistical analysis further comprises determining the counts of pixels that are within the series of bins per each channel of the first 2D map, or determining the counts of the pixels that are within the series of bins per a combined channel comprising two or more channels of the first 2D map.

5. The method of claim 1, wherein the respective values each comprise a distance and/or wherein the first statistical analysis corresponds to each labeled region of a same category of the first 2D map.

6. The method of claim 1, wherein the 3D representation of the scene includes at least one of a point cloud, a mesh, or a voxel grid.

7. The method of claim 1, wherein the preferred transformation type represents a configuration of a set of features including at least one of height, normal vector, surface details, and curvature.

8. The method of claim 1, wherein the image processing application comprises using a deep learning network to perform classification, anomaly detection, and/or segmentation of the 3D representation of the scene.

9. The method of claim 1, wherein the image processing application comprises using a 2D deep learning model that was pre-trained using a set of 2D images.

10. The method of claim 1, wherein the first statistical analysis corresponds to the entire map of the first 2D map.

11. The method of claim 1, wherein the 3D representation is a first 3D representation, the method further comprising:
receiving a second 3D representation; and
repeating steps (b)-(f) for the second 3D representation.

12. The method of claim 11, wherein the second 3D representation is of the scene.

13. The method of claim 11, wherein the second 3D representation is of a different scene.

14. The method of claim 11, wherein:
the first 3D representation is within a first category,
the second 3D representation is within a second category, and
the method further comprises:
receiving a third 3D representation within the first category,
repeating steps (b)-(f) for the third 3D representation,
receiving a fourth 3D representation within the second category, and
repeating steps (b)-(f) for the fourth 3D representation,
wherein analyzing the statistical analyses comprises using criteria, including:
a consistency among training samples within each category of a plurality of categories including the first and second category; or
a distance between each training sample and a nearest neighbor of the training sample, and
wherein the training samples include the 2D maps derived from the first 3D representation, the second 3D representation, the third 3D representation, and the fourth 3D representation.

15. (canceled)

16. The method of claim 11, wherein analyzing the first statistical analysis and the second statistical analysis to obtain the respective values comprises:
comparing the first statistical analysis of the first 3D representation to the first statistical analysis of the second 3D representation; and
comparing the second statistical analysis of the first 3D representation to the second statistical analysis of the second 3D representation.

17. The method of claim 14, further comprising identifying the nearest neighbor for each training sample, wherein identifying the nearest neighbor includes determining a normalized Gaussian distance between two statistical analyses of a same transformation type.

18. (canceled)

19. The method of claim 1, wherein the first statistical analysis comprises:
a labeled statistical analysis corresponding to a labeled region of a training sample, the training sample including the first 2D map;
a surrounding statistical analysis corresponding to an area surrounding the labeled region of the training sample;
analyzing a difference between the labeled statistical analysis and the surrounding statistical analysis; and
measuring the difference between the labeled statistical analysis and the surrounding statistical analysis using a dissimilarity feature, wherein the dissimilarity feature comprises a distance between two corresponding statistical analyses.

20. (canceled)

21. (canceled)

22. (canceled)

23. The method of claim 19, wherein:
the 3D representation includes a first 3D representation portion within a first category,
the at least a portion of the first 2D map and the at least a portion of the second 2D map correspond to the first 3D representation portion,
the second statistical analysis comprises:
a second labeled statistical analysis corresponding to a second labeled region of a second training sample, the second training sample including the second 2D map; and
a second surrounding statistical analysis corresponding to an area surrounding the second labeled region of the second training sample, and
the method further comprises:
receiving a second 3D representation within a second category and repeating steps (b)-(f) for the second 3D representation, and/or
generating a third statistical analysis corresponding to at least a second portion of the first 2D map and generating a fourth statistical analysis corresponding to at least a second portion of the second 2D map, wherein the second portions correspond to a second 3D representation portion within a second category of the 3D representation, wherein the first statistical analysis and the second statistical analysis of the first 3D representation portion are compared to:
the first and second statistical analysis of the 2D map of the second 3D representation, respectively, and/or
the third and fourth statistical analysis.

24. (canceled)

25. The method of claim 23, further comprising selecting the first category or the second category based on the comparison for each of the first transformation type and second transformation type, and further comprising selecting the first transformation type or second transformation type based at least in part on a dissimilarity feature.

26. (canceled)

27. (canceled)

28. A system comprising at least one processor configured to perform:
(a) receiving a 3D representation of a scene;
(b) transforming the 3D representation of the scene to a first 2D map for a first transformation type;
(c) transforming the 3D representation of the scene to a second 2D map for a second transformation type;
(d) generating a first statistical analysis corresponding to at least a portion of the first 2D map;
(e) generating a second statistical analysis corresponding to at least a portion of the second 2D map;
(f) obtaining respective values by analyzing the first statistical analysis and the second statistical analysis; and
(g) identifying a preferred transformation type from the first and second transformation types based at least in part on the respective values.

29. A non-transitory computer readable medium comprising program instructions that, when executed, cause at least one processor to perform:
(a) receiving a 3D representation of a scene;
(b) transforming the 3D representation of the scene to a first 2D map for a first transformation type;
(c) transforming the 3D representation of the scene to a second 2D map for a second transformation type;
(d) generating a first statistical analysis corresponding to at least a portion of the first 2D map;
(e) generating a second statistical analysis corresponding to at least a portion of the second 2D map;
(f) obtaining respective values by analyzing the first statistical analysis and the second statistical analysis; and
(g) identifying a preferred transformation type from the first and second transformation types based at least in part on the respective values.
